(19) United States
(12) Patent Application Publication
(10) Pub. No.: US 2023/0030102 A1
(43) Pub. Date: Feb. 2, 2023

(54) PEOPLE CONVEYOR ARRANGEMENT AND A METHOD FOR TESTING COMPONENTS AND/OR FUNCTIONS OF THE PEOPLE CONVEYOR

(71) Applicant: KONE Corporation, Helsinki (FI)

(72) Inventors: Mika BELOV, Helsinki (FI); Mikko PIIRONEN, Helsinki (FI)

(73) Assignee: KONE Corporation, Helsinki (FI)

(21) Appl. No.: 17/964,493

(22) Filed: Oct. 12, 2022

Related U.S. Application Data
(63) Continuation of application No. PCT/FI2020/050317, filed on May 13, 2020.

(51) Int. Cl. B66B 5/00; B66B 25/00; B66B 1/34; G05B 15/02

(52) U.S. Cl. CPC B66B 5/0087; B66B 25/006; B66B 1/3461; G05B 15/02

(57) ABSTRACT

A people conveyor arrangement and a method for testing components and/or functions of the people conveyor in a people conveyor arrangement including at least one remote computing device and/or local computing device, and at least one communication channel and an application programming interface arranged between the people conveyor component and the at least one computing device. The method includes sending from the at least one computing device test related data via an application programming interface to a component of the people conveyor, receiving test related data via the application programming interface by the component when the component is connected to the communication channel, and responding from the component of the people conveyor to the local computing device and/or to the remote computing device via the application programming interface that the test related data was received and/or that a test was carried out or emulated based on the test related data.

### TECHNICAL FIELD

The invention relates to a people conveyor arrangement and a method for testing components and/or functions of the people conveyor, such as an elevator, an escalator and/or a moving walkway.

### BACKGROUND

More and more applications and devices are installed in connection with the people conveyor systems, such as elevator systems, escalator systems and moving walkway systems. Some examples of such applications and devices are infotainment solutions and CCTV solutions which can be installed e.g. to elevator cars. All these devices need communication channel to be able to operate correctly.

Usually is not advantageous to directly let the different components of the conveyor system, such as an elevator system, to access for example the control unit of the conveyor device. Instead, the accessing can be done through an application programming interface. An application programming interface (API) is a computing interface to a software component or a system, that defines how other components or systems can use it. It defines the kinds of calls or requests that can be made, how to make them, the data formats that should be used, the conventions to follow, etc.

In the prior art solutions, the installation personnel have taken care of testing that the API-interface is operational at the conveyor site and that all the required components and devices can be accessed via the application programming interface in the installation and commissioning phase of the conveyor site. This is however a time-consuming process in which also errors are easily made. In addition, often multiple parties at different locations are required for the testing to be successful. For these reasons there is a clear need for an improved testing solution for the components and API in conveyor system environment.

### SUMMARY

An object of the invention is to present a people conveyor arrangement and a method for testing components and/or functions of the people conveyor. In the solution of the invention the testing can be carried out automatically and no manual work at the people conveyor site is required.

According to a first aspect, the invention relates to a method for testing components and/or functions of a people conveyor, such as an elevator, an escalator and/or a moving walkway, in a people conveyor arrangement comprising at least one remote computing device and/or local computing device, and at least one communication channel and an application programming interface (API) arranged between the people conveyor component and the at least one computing device. The method comprises sending from the at least one computing device test related data, e.g. a test pattern, via an application programming interface to a component of the people conveyor, receiving the test related data, e.g. test pattern, via the application programming interface by the component when the component is connected to the communication channel, and responding from the component of the people conveyor to the local computing device and/or to the remote computing device via the application programming interface that the test related data, e.g. test pattern, was received and/or that a test was carried out or emulated based on the test related data, e.g. test pattern.

In one embodiment of the invention the one computing device is sending the test related data, e.g. at least one test pattern, continuously and/or at predefined intervals for so long that that it receives a response from the people conveyor component.

In one embodiment of the invention the response from the at least on components comprises an indication that end-to-end application programming interface is operational and/or a request to the least one remote computing device and/or local computing device to disable sending test related data, e.g. test pattern.

In one embodiment of the invention test related data, e.g. the test patterns, are established on the at least one computing device and/or requested from an external service and/or remote system based on people conveyor site configuration data comprising list of different components and/or functions of the people conveyor.

In one embodiment of the invention carrying out a test of the people conveyor component and/or function is done by emulating operation and/or data type format of the people conveyor component and/or function of the people conveyor component in such a way that the test according to the test related data, e.g. test pattern, is not affecting operation of the people conveyor.

In one embodiment of the invention the people conveyor comprises an application programming interface controller which implements the application programming interface and enables the communication between the people conveyor component and the at least one computing device.

In one embodiment of the invention the application programming interface controller is integrated to a people conveyor controller, such as an elevator controller, an escalator controller and/or a moving walkway controller.

In one embodiment of the invention the at least one computing device sending the test related data, e.g. test pattern, is an application programming interface backend service which is a cloud application programming interface service or a local application programming interface service.

In one embodiment of the invention the least one remote computing device and/or local computing device additionally performs tests relating to the technical quality of the communication channel the people conveyor component is using, such as tests relating to response time and/or latency.

According to a second aspect, the invention relates to a people conveyor arrangement for testing components and/or functions of the people conveyor, such as an elevator, an escalator and/or a moving walkway, the arrangement comprising at least one remote computing device and/or local computing device, and at least one communication channel and an application programming interface (API) arranged between a people conveyor component and the at least one computing device. The arrangement is configured to send from the at least one computing device test related data, e.g. a test pattern, via an application programming interface to a component of the people conveyor, to receive test related data, e.g. the test pattern, by the component via the application programming interface when the component is connected to the communication channel, and to respond from the component of the people conveyor to local computing device and/or to the remote computing device via the application programming interface that the test related data, e.g. test pattern, was received and/or that a test was carried out or emulated based on test related data, e.g. the test pattern.

According to a third aspect, the invention relates a computer program comprising instructions which, when executed by a computer, cause the computer to carry out the method according to the solution of the invention.

According to a fourth aspect, the invention relates to a computer-readable medium comprising the computer program according to the solution of the invention.

According to a fifth aspect, the invention relates to an application programming interface (API) for a people conveyor arrangement, such as an elevator, an escalator and/or a moving walkway, the people conveyor arrangement comprising at least one people conveyor component, at least one remote computing device and/or local computing device and at least one communication channel, wherein the at least one communication channel and the application programming interface are arranged between the people conveyor component and the at least one computing device. The application programming interface (API) is configured to receive from the at least one computing device test related data, e.g. at least one test pattern, to send, based on the received test related data, e.g. test pattern, the test related data, e.g. test pattern, to the at least one component of the people conveyor, to receive a response from the at least one component of the people conveyor that the test related data, e.g. test pattern, was received and/or that a test was carried out or emulated based on the test related data, e.g. test pattern, and to send a response to local computing device and/or to the remote computing device based on the response received from the component of the people conveyor.

The solution of the invention is able to provide an automatic testing solution in which no manual actions are required from the service and/or installation personnel for testing site API interface and/or the conveyor system components as with the prior art solutions.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

The embodiments of the invention are illustrated by way of example, and not by way of limitation, in the figures of the accompanying drawings, in which:

FIG. 1 illustrates an elevator according to one embodiment of the invention,

FIG. 2 illustrates an escalator according to one embodiment of the invention, and

FIG. 3 presents a flow chart illustrating a method according to one embodiment of the invention.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

Reference will now be made in detail to the embodiments of the present invention, examples of which are illustrated in the accompanying drawings.

The solution of the invention is related to people conveyor related API service automatic operation testing which can be used e.g. during conveyor site installation and/or commissioning phase. The solution of the invention can comprise sub-components and/or functions, for example an API interface controller, which can be integrated to conveyor controller, such as elevator, escalator or moving walkway controller. The solution of the invention may also comprise an API backend solution which can be based on cloud solution or service and/or conveyor site solution, such as a computer located in connection with the conveyor site. API backend solution may contain automatic or manual management interface that can be used for registering a new API site, update/modify the existing device settings, e.g. enabling new API interfaces, or to provide integration access to 3rd party API service. Connectivity between the solution components can be wired or wireless.

In one embodiment of the invention a remote system, such as a cloud service, and/or a local system sends test related data, e.g. test data patterns, to the people conveyor site system via an application programming interface (API). Result of the testing is then sent back to the remote and/or local system for verifying e.g. the operation of the API interface and/or the components or units using the API interface. Test related data, e.g. test data patters may be created by the also by 3rd party developers.

Test related data can comprise any data which can be used in testing of the components and/or communication and/or the application programming interface, such as data comprising a test pattern, data relating to sending and/or collecting data for new or existing tests, data for creating tests and/or disabling and/or updating existing tests.

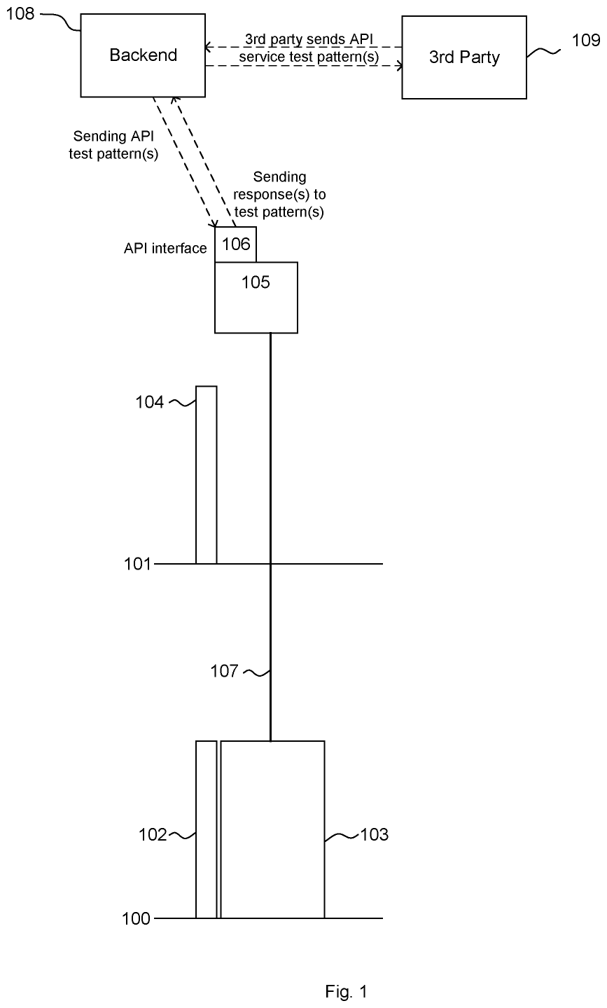

FIG. 1 schematically illustrates an embodiment according to the present invention in which the people conveyor is an elevator in which the solution of the invention can be used. In FIG. 1 an elevator car 103 presented, which can stop in a first floor 100 and a second floor 101. The floors may be any floor in a building and not necessarily the first and second floor of the building. The first floor 100 may be, for example, garage and the second floor 101 the ground level. A landing door 102 of the first floor is arranged in front of the elevator car 103. In FIG. 1 a similar arrangement can be seen at the second floor 101 where a landing door 104 of the second floor is arranged. In FIG. 1 rope 107 is a hoisting rope and used for operating the elevator. This arrangement is, however, only an example. The API interface controller 106 may be arranged in connection to the conveyor control unit 105 and/or integrated to conveyor control unit 105, such as an elevator control unit.

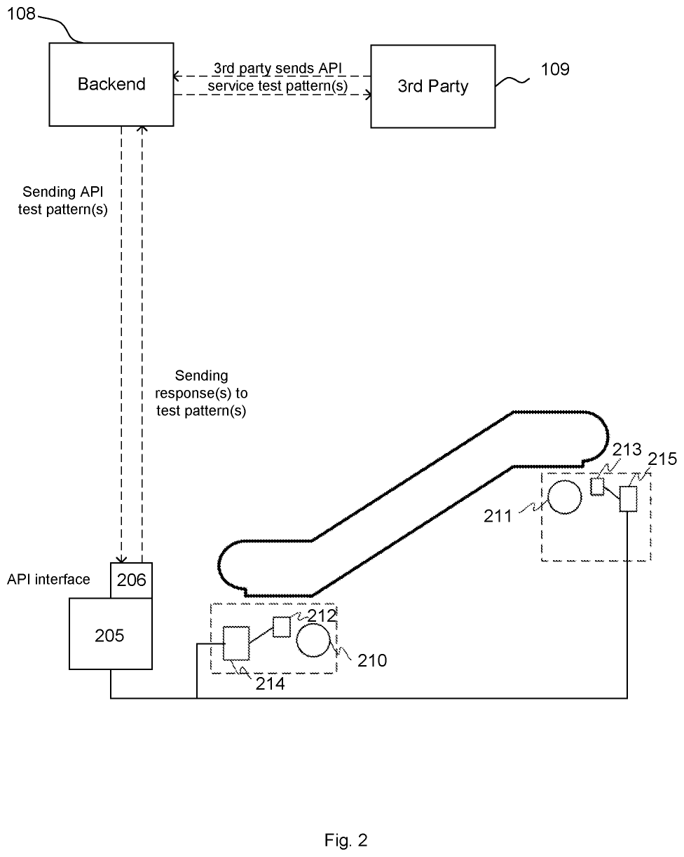

FIG. 2 schematically illustrates an embodiment according to the present invention in which the conveyor is an escalator 200 in which the solution of the invention can be used. The escalator system may comprise a step-chain coupled to a motor 210 via a transmission 212 comprising at least a chain or belt or similar. The motor 210 may generate a rotational force via the transmission causing the step-chain to move in an intended travelling direction. A brake may be arranged to the conveyor system so that when de-energized it is configured to meet the rotating axis of the transmission and, in that manner, to brake movement of the step chain or keep the step chain standstill when the escalator system is idle. When energized, the brake opens, allowing movement of step-chain. The transmission may comprise, in the context of escalator system, a gearbox with the mentioned entities. Furthermore, the escalator system may comprise a conveyor control unit 205 which may e.g. be configured to control the movement of step-chain through a control of a power supply to the motor 220 and to the escalator brake. In one embodiment of the invention the conveyor system can comprise a processing unit 214. In some embodiments a second motor 211 with a second transmission 213 may be provided, for example, at the opposite end of the step-chain. Then a second processing unit 215 may be mounted to the in connection with the second motor. The API interface controller 206 may be arranged in connection to the conveyor control unit 205 and/or integrated to conveyor control unit 205, such as an escalator control unit.

In the solution of the invention the components and functions of a people conveyor device can be tested automatically. The people conveyor can be e.g. the elevator system presented in FIG. 1 or an escalator system presented in FIG. 2. The solution uses at least one computing device, such as a computer, for sending the and/or establishing the test patterns. The computing device can be e.g. a remote computing device 108, such as a server, or a cloud service or a local computing device which is installed to the conveyor site. In one embodiment of the invention there may be both remote computing device 108 and local computing device.

At least one communication channel and an application programming interface (API) is arranged between the people conveyor component and the at least one computing device. In the solution of the invention test related data, e.g. a test pattern, is sent from at least one computing device via an application programming interface to a component of the people conveyor. The component receives the test related data, e.g. test pattern, via the application programming interface after the component has established a connection to the communication channel. After receiving the test related data, e.g. test pattern, the component can respond based on the received test related data, e.g. test pattern. The response can be sent via the application programming interface to the computing device which can be a remote and/or local computing device. The response may comprise an indication that the test related data, e.g. test pattern was received and/or that a test was carried out or emulated based on the test related data, e.g. test pattern. This way the system is able to know that application programming interface is operational with the tested component.

Testing of the communication with the components and API interface can be carried out as described above for so long that every component is tested. After successfully testing the API interface with every component and/or function, the site installation and/or commissioning can proceed to the next phase.

In one embodiment of the invention the one computing device is sending the test related data, e.g. at least one test pattern, continuously and/or at predefined intervals for so long that that it receives a response from the people conveyor component.

In one embodiment of the invention the response from the at least on components comprises an indication that end-to-end application programming interface is operational and/or a request to the least one remote computing device and/or local computing device to disable sending test pattern or test related data.

In one embodiment of the invention the test related data, e.g. test patterns are established on the at least one computing device and/or requested from an external service 109 and/or remote system based on people conveyor site configuration data comprising list of different components and/or functions of the people conveyor.

In one embodiment of the invention carrying out a test of the people conveyor component and/or function is done by emulating operation and/or data type format of the people conveyor component and/or function of the people conveyor component in such a way that the test according to the test related data, e.g. test pattern, is not affecting operation of the people conveyor.

In one embodiment of the invention the people conveyor comprises an application programming interface controller which implements the application programming interface and enables the communication between the people conveyor component and the at least one computing device.

In one embodiment of the invention the application programming interface controller is integrated to a people conveyor controller, such as an elevator controller, an escalator controller and/or a moving walkway controller.

In one embodiment of the invention the at least one computing device sending test related data, e.g. the test pattern, is an application programming interface backend service which is a cloud application programming interface service or a local application programming interface service.

In one embodiment of the invention the least one remote computing device and/or local computing device additionally performs tests relating to the technical quality of the communication channel the people conveyor component is using, such as tests relating to response time and/or latency.

In the following a more detailed example use case scenario is described in which the solution of the invention can be used. In this example a new site with API connectivity and/or integration is created in a cloud backend system. First the required API services are enabled. Based on entered information the cloud backend system starts sending test data, such as a test pattern or test patters. Test data, such as test pattern(s) is/are created based on the enabled/selected API functionalities. The backend system can also request test related data or test pattern(s) from external API service provider. API test data and/or test pattern can be sent periodically, e.g. certain specified amount seconds, minutes, hours, day and/or week, and continued until operation confirmation received. Confirmation can be done manually or automatically. In a case confirmation is not received within expected timeline the backend system may indicate administrator to check the case status or create support request for the site technician. When a device at the conveyor site is connected, the device may automatically connect to the cloud backend system. Based on the cloud backend pre-configuration (e.g. a new site with API connectivity is created or a new API functionality is enabled for an already existing API enabled site), the conveyor site starts receiving API test pattern from cloud backend system or from a third party cloud backend system. When the API test data or test pattern is received, the site device can indicate, e.g. locally and/or to the cloud backend system, that end-to-end API solution is operational and/or send request e.g. to local system and/or to the cloud backend system, to disable sending test related data or test pattern. In one embodiment of the invention carrying out a test according to the received test pattern is not creating elevator call or affecting already running conveyor operation. In one embodiment the test can be carried out by emulating the correct type data format and/or operation without having effect on the actual operation of the conveyor device. In one embodiment of the invention, the cloud backend system can also perform some additional testing, determining other technical parameters of the connection to a component, such as response time and/or latency. When the cloud backend system has received a confirmation that the conveyor site API is operational with the required components, it can allow the site commissioning process next step execution.

In one embodiment of the invention at least part of the functionality described with the earlier examples can be performed locally at the people conveyor site, e.g. by a site application programming interface (site API) with a local computing device.

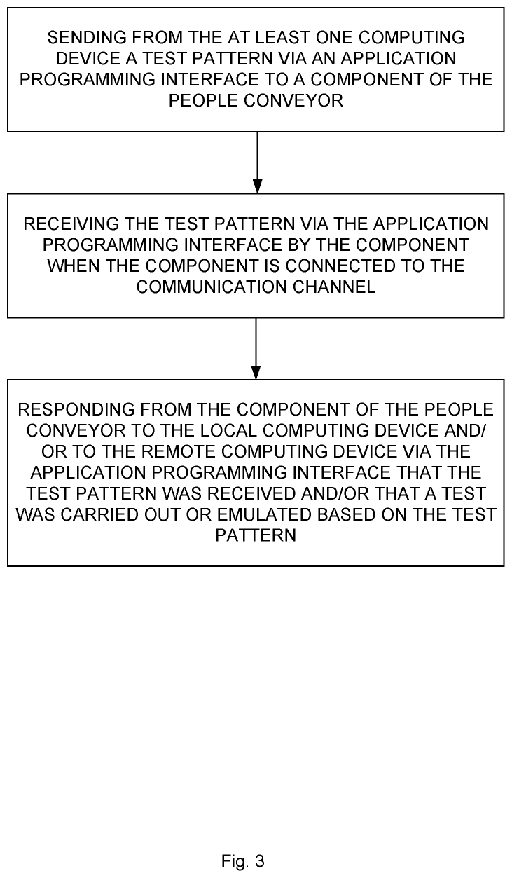

In FIG. 3 a method according to an example embodiment is disclosed. The method is initiated by sending from the at least one computing device a test pattern via an application programming interface to a component of the people conveyor. The test pattern is received via the application programming interface by the component when the component is connected to the communication channel. After being connected to the communication channel and receiving the test pattern the method continues to responding from the component of the people conveyor to the local computing device and/or to the remote computing device via the application programming interface that the test pattern was received and/or that a test was carried out or emulated based on the test pattern.

The transmissions, e.g. sending requests, test patterns and/or responses described above, may be performed by using a wireless or wired transmitter. The transmitter may be an independent transmitter using mobile communication networks, Wi-Fi or similar. However, it is also possible to use the transmission channels that are dedicated particularly for a certain unit and/or part on the people conveyor, e.g. in the case of an elevator, a specific elevator car. The transmission may be encrypted. The transmission needs not to be a direct transmission but may involve any number of network elements in between. Thus, using an ordinary wireless internet connection is acceptable provided that the required units are able to receive the transmission.

A controller of a conveyor in which the solution of the invention can be used may comprise at least one processor connected to at least one memory. The at least one memory may comprise at least one computer program which, when executed by the processor or processors, causes the controller to perform the programmed functionality. In another embodiment, the at least one memory may be an internal memory of the at least one processor. The controller may also comprise an input/output interface. Via the input/output interface, the control apparatus may be connected to at least one wireless device. The controller may be a control entity configured to implement only the above disclosed operating features, or it may be part of a larger elevator control entity, for example, an elevator controller or an elevator group controller.

As stated above, the components or other parts of the exemplary embodiments can include computer readable medium or memories for holding instructions programmed according to the teachings of the present embodiments and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD1RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge or any other suitable medium from which a computer can read.

It is obvious to a person skilled in the art that with the advancement of technology, the basic idea of the optically readable comprising parameters may be implemented in various ways. The optically readable code arranged in connection with a conveyor component and its embodiments are thus not limited to the examples described above; instead they may vary within the scope of the claims. While the present inventions have been described in connection with a number of exemplary embodiments, and implementations, the present inventions are not so limited, but rather cover various modifications, and equivalent arrangements, which fall within the purview of prospective claims.

The embodiments of the invention described hereinbefore in association with the figures presented and the summary of the invention may be used in any combination with each other. At least two of the embodiments may be combined together to form a further embodiment of the invention.

The specific examples provided in the description given above should not be construed as limiting the applicability and/or the interpretation of the appended claims. Lists and groups of examples provided in the description given above are not exhaustive unless otherwise explicitly stated.

1. A method for testing components and/or functions of a people conveyor, such as an elevator, an escalator and/or a moving walkway, in a people conveyor arrangement comprising at least one remote computing device and/or local computing device, and at least one communication channel and an application programming interface arranged between the people conveyor component and the at least one computing device, wherein the method comprises:
sending from the at least one computing device test related data, such as a test pattern, via an application programming interface to a component of the people conveyor,
receiving the test related data, such as the test pattern, via the application programming interface by the component when the component is connected to the communication channel, and
responding from the component of the people conveyor to the local computing device and/or to the remote computing device via the application programming interface that the test related data, such as the test pattern, was received and/or that a test was carried out or emulated based on the test related data, such as the test pattern.

2. A method according to claim 1, wherein the at least one computing device is sending test related data, e.g. at least one test pattern, continuously and/or at predefined intervals for so long that that it receives a response from the people conveyor component.

3. A method according to claim 1, wherein the response from the at least on components comprises an indication that end-to-end application programming interface is operational and/or a request to the least one remote computing device and/or local computing device to disable sending test related data, e.g. the test pattern.

4. A method according to claim 1, wherein the test related data, e.g. the test patterns, are established on the at least one computing device and/or requested from an external service and/or remote system based on people conveyor site configuration data comprising list of different components and/or functions of the people conveyor.

5. A method according to claim 1, wherein carrying out a test of the people conveyor component and/or function is done by emulating operation and/or data type format of the people conveyor component and/or function of the people conveyor component in such a way that the test according to the test related data, e.g. test pattern, is not affecting operation of the people conveyor.

6. A method according to claim 1, wherein the people conveyor comprises an application programming interface controller which implements the application programming interface and enables the communication between the people conveyor component and the at least one computing device.

7. A method according to claim 6, wherein the application programming interface controller is integrated to a people conveyor controller, such as an elevator controller, an escalator controller and/or a moving walkway controller.

8. A method according to claim 1, wherein the at least one computing device sending the test related data, e.g. the test pattern, is an application programming interface backend service which is a cloud application programming interface service or a local application programming interface service.

9. A method according to claim 1, wherein the least one remote computing device and/or local computing device additionally performs tests relating to the technical quality of the communication channel the people conveyor component is using, such as tests relating to response time and/or latency.

10. A method according to claim 1, wherein new tests are defined and/or created for the component of the people conveyor through the application programming interface.

11. A people conveyor arrangement for testing components and/or functions of the people conveyor, such as an elevator, an escalator and/or a moving walkway, the arrangement comprising at least one remote computing device and/or local computing device, and at least one communication channel and an application programming interface arranged between a people conveyor component and the at least one computing device, wherein the arrangement is configured:
to send from the at least one computing device test related data, e.g. a test pattern, via an application programming interface to a component of the people conveyor,
to receive the test related data, e.g. the test pattern, by the component via the application programming interface when the component is connected to the communication channel, and
to respond from the component of the people conveyor to local computing device and/or to the remote computing device via the application programming interface that the test related data, e.g. the test pattern, was received and/or that a test was carried out or emulated based on the test related data, e.g. the test pattern.

12. A people conveyor arrangement according to claim 11, wherein the at least one computing device is configured to send the test related data, e.g. at least one test pattern, continuously and/or at predefined intervals for so long that that it receives a response from the people conveyor component.

13. A people conveyor arrangement according to claim 11, wherein the response from the at least on components comprises an indication that end-to-end application programming interface is operational and/or a request to the least one remote computing device and/or local computing device to disable sending test related data, e.g. test pattern.

14. A people conveyor arrangement according to claim 11, wherein the at least one computing device is configured to establish test related data, e.g. the test pattern, and/or to request test related data, e.g. the test pattern, from an external service and/or remote system based on people conveyor site configuration data comprising list of different components and/or functions of the people conveyor.

15. A people conveyor arrangement according to claim 11, wherein the people conveyor component is configured to carry out a test of the component or function by emulating operation and/or data type format of the people conveyor component and/or function of the people conveyor component in such a way that the test according to the test related data, e.g. test pattern, is not affecting operation of the people conveyor.

16. A people conveyor arrangement according to claim 11, wherein the people conveyor comprises an application programming interface controller configured to implement the application programming interface and to enable the communication between the people conveyor component and the at least one computing device.

17. A people conveyor arrangement according to claim 16 wherein the application programming interface controller is integrated to a people conveyor controller, such as an elevator controller, an escalator controller and/or a moving walkway controller.

18. A people conveyor arrangement according to claim 11, wherein the at least one computing device configured to send test related data, e.g. the test pattern, is an application programming interface backend service, such as a cloud application programming interface service or a local application programming interface service.

19. A people conveyor arrangement according to claim 11, wherein the least one remote computing device and/or local computing device is configured to additionally performs tests relating to the technical quality of the communication channel the people conveyor component is using, such as tests relating to response time and/or latency.

20. A people conveyor arrangement according to claim 11, wherein the arrangement is configured to define and/or create new tests for the component of the people conveyor through the application programming interface.

21. A people conveyor arrangement according to claim 11, wherein
the people conveyor is an elevator comprising an elevator car, a motor configured to move the elevator car and an elevator controller configured to control the elevator and/or the motor, or
the people conveyor is an escalator comprising steps, step chain, a motor configured to move the step chain and an escalator controller configured to control the escalator and/or the motor, or
the people conveyor is a moving walkway comprising pallets, pallet chain, a motor configured to move the pallet chain and a moving walkway controller configured to control the moving walkway and/or the motor.

22. A computer program comprising instructions which, when executed by a computer, cause the computer to carry out the method according to claim 1.

23. A non-transitory computer-readable medium comprising the computer program according to claim 22.

24. An application programming interface for a people conveyor arrangement, such as an elevator, an escalator and/or a moving walkway, the people conveyor arrangement comprising at least one people conveyor component, at least one remote computing device and/or local computing device and at least one communication channel,
wherein the at least one communication channel and the application programming interface are arranged between the people conveyor component and the at least one computing device, and
wherein the application programming interface is configured:
to receive from the at least one computing device test related data, e.g. at least one test pattern,
to send, based on the received test related data, e.g. test pattern, the test related data, e.g. the test pattern, to the at least one component of the people conveyor,
to receive a response from the at least one component of the people conveyor that the test related data, e.g. the test pattern, was received and/or that a test was carried out or emulated based on the test related data, e.g. test pattern, and
to send a response to local computing device and/or to the remote computing device based on the response received from the component of the people conveyor.
